(19) United States
(12) Patent Application Publication
(10) Pub. No.: US 2014/0214486 A1
(43) Pub. Date: Jul. 31, 2014

(54) Dual Push Sales Of Time Sensitive Inventory

(71) Applicant: Alexander Greystoke, Austin, TX (US)

(72) Inventor: Alexander Greystoke, Austin, TX (US)

(21) Appl. No.: 14/169,060

(22) Filed: Jan. 30, 2014

Related U.S. Application Data
(60) Provisional application No. 61/759,317, filed on Jan. 31, 2013.

(51) Int. Cl. G06Q 30/02; G06Q 30/06

(52) U.S. Cl. CPC G06Q 30/0264; G06Q 30/0201; G06Q 30/0269; G06Q 30/0631
USPC 705/7.29

(57) ABSTRACT

Methods and apparatus, including computer program products, are provided for continuous dual push sales. The method may include, inter alia, determining a continuous real time distribution channel, comprising at least one match of said at least one customer specification and said at least one supplier specification, wherein said real time distribution channel determination comprises at least a dynamic pricing of the set of the desired item, upsells and cross-sells; conducting a sale wherein the offered item of said determined real time distribution channel is made available to said at least one potential customer; collecting non-winner data from said at least one potential customer that was not selected as the at least one winning customer; and delivering the collected non-winner data to said at least one supplier. Related apparatus, systems, methods, and articles are also described.

### CROSS REFERENCE TO RELATED APPLICATION

This application claims the benefit of priority under 35 U.S.C. §119(e) of U.S. provisional patent application No. 61/759,317, entitled “Dual Push Sales of Time Sensitive Inventory,” filed on Jan. 31, 2013. The contents of the above-identified application are incorporated herein by reference in their entirety.

### FIELD OF INVENTION

The subject matter disclosed herein relates to data processing, and, in particular, a continuous, real-time, intelligent, dual push sales of time sensitive inventory.

### BACKGROUND

Current systems of assisting in the purchase of an item typically take the form of a search performed by the potential customer that yields a snapshot of inventory offerings at that moment in time. Once that search snapshot is displayed, the potential customer is made aware of what is available at that moment in time. However, this search often yields few, if any, results that are useful for the ever changing demands of a purchasing consumer, especially in the case of perishable goods/services, such as travel and the like.

### SUMMARY

In some example embodiments, there is provided a method. The method may include receiving at least one customer specification from at least one potential customer of an expression of interest in purchasing a specific item; receiving at least one supplier specification from at least one supplier of an expression of interest in offering an item whose sales value has a limited lifetime; determining a real time distribution channel, comprising at least one match of said at least one customer specification and said at least one supplier specification, wherein said real time distribution channel determination comprises at least a dynamic pricing of the set of the desired item, upsells and cross-sells; conducting a sale wherein the offered item of said determined real time distribution channel is made available to said at least one potential customer; selecting at least one winning customer of said sales from said at least one potential customer; collecting non-winner data from said at least one potential customer that was not selected as the at least one winning customer; and delivering the collected non-winner data to said at least one supplier.

Articles are also described that comprise a tangibly embodied computer-readable medium embodying instructions that, when performed, cause one or more machines (for example, computers, etc.) to result in operations described herein. Similarly, apparatus are also described that can include a processor and a memory coupled to the processor. The memory can include one or more programs that cause the processor to perform one or more of the operations described herein.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

FIG. 1 depicts a system for providing dual push sales of time sensitive inventory;

FIG. 2 depicts a second method of providing dual push sales of time sensitive inventory;

FIG. 3 depicts the customer specification;

FIG. 4 depicts a third method of providing dual push sales of time sensitive inventory;

FIG. 5 depicts a system of providing dual push sales of time sensitive inventory;

FIG. 6 depicts a second system of providing dual push sales of time sensitive inventory;

FIG. 7 depicts a computer readable medium of providing dual push sales of time sensitive inventory;

FIG. 8 depicts storage of a second computer readable medium of providing dual push sales of time sensitive inventory;

FIG. 9 depicts storage of a third computer readable medium of providing dual push sales of time sensitive inventory;

FIG. 10 depicts an example of a flowchart, in accordance with some example implementations; and

FIG. 11 depicts another flowchart, in accordance with some example implementations.

### DETAILED DESCRIPTION

The problem of how to sell distressed, time sensitive and perishable inventory has been a problem suppliers have been looking to solve for many years but existing solutions are unsatisfactory. Suppliers in many sectors want to maximize sales of inventory while also maximizing the price per unit sold while at the same time minimizing core price degradation. The fundamental problem is that suppliers from different industries have differing reasons why inventory has become distressed, time sensitive or perishable, which would indicate that a variety of solutions are needed. Current systems are inadequate at achieving this objective for distressed, time sensitive or perishable inventory.

Movie theaters will ordinarily have a significant number of unsold seats on a Tuesday or Wednesday evening, not because they have misread demand but because potential customer behavior results in this outcome. The movie theatre is built for maximum capacity but this is not often achieved, even for peak periods. The problem of how to sell unsold seats is particularly felt as the core profit center for the movie theatre is the concessions purchased by customers when they visit. Concession sales at a movie theater would be considered an upsell, as it is a secondary high margin sale that is directly related to the primary purchase, but that will not occur without the sale of the primary purchase.

Restaurants suffer from both the same problem as the movie theater and a secondary issue of potential customers cancelling reservations often very near in time to when the transaction was to take place. The problem of how to fill empty tables, particularly very late in the day is a significant one.

Grocery stores stock a very large number of a variety of items which have a finite shelf life. The grocery store does not sell every item prior to its shelf life expiry and as a result they have perishable inventory.

Pharmaceuticals are similar in that they have an expiry date, beyond which they are non-saleable. Similarly, pharmaceutical products that have been issued to a customer but not used are non-saleable as are products that are discontinued or have a production defect.

With respect to the travel and recreation industry, unsold inventory may arise due to an inability for a potential customer looking for late available inventory to find and book such inventory quickly and efficiently. This is a known problem for airline and cruise inventory, and also a particular problem for holiday villas and apartment space where there is no apparent real time distribution channel, no dynamic pricing, and no ability to simultaneously or near simultaneously negotiate pricing on near expiring inventory with a multiplicity of suppliers. Transactions may be hindered due in part to suppliers' inability to find potential customers looking for their product and potential customers' inability to locate the products that they are looking for and customers' inability to get real time data on availability or pricing of product.

Additionally, issues may arise due to unexpected, geopolitical, or economic events such as the Japanese nuclear disaster. In this instance, travel to Japan fell 25% and global travel fell nearly ten percent. The result was immediate, unanticipated unsold inventory in bulk that required discounting.

Further, sales of upsells may be limited due to suppliers' inability to create dynamic pricing for upsells that will have diminishing value and no current method to efficiently communicate with a potential customer very late in the day, for example at the point of departure or post arrival. Examples of upsells would include an airline that sells an exit row or upgrade to business class or priority boarding, an upgrade at a hotel or on a cruise ship or the previously mentioned concessions at a movie theater, and the like.

A closely aligned issue arises when a potential customer who is offered a limited quantity fixed price product or a heavily discounted product for bidding is subsequently beaten to the purchase or outbid. In current systems, this potential customer and those in a similar position are left unsatisfied except in the case of bidding where their bid is within a very close, fixed percentage of what the winning bid is. The result is nearly all their potential transactions are left unfilled.

Some of the issues that immediately present themselves are, discrepancies between forecast supply and actual demand, sudden changes in potential customer behavior, unforeseen events, difficulties in efficiently and discreetly communicating with potential customers about available items very late in the day, inability to communicate and efficiently form a distribution channel for upsells and cross-sells very late in the day and an inability to dynamically price the same and an inability to meet the needs of potential customers who may form a viable second tier market.

The subject matter disclosed herein may, in some implementations, solve each of the described problems. The described method, system and computer readable medium may allow suppliers to move distressed, time sensitive or perishable inventory at a point in time when the possibility of a sale is remote. The inventory is offered in real time, confidentially and on a highly targeted and intelligent basis whereby potential customers are shown exactly the product they are seeking, when they are looking for it and meeting whatever precise preferences they specify in the system and more specifically the customer portal. The supplier fully controls what product is made available, at what price and may segment who is offered the item and when. The potential customer no longer has to search for the product he wants and now has access to non-public inventory at discounted prices and personalized to his exact specifications. The supplier may discreetly push out product that has a very remote possibility of sale to potential customers looking for that exact product at that time.

Therefore, what is needed is a dual push sale of time sensitive inventory. More specifically, what is needed is the creation of a distribution channel between the seller and the buyer in which both have detailed information pushed to them to facilitate a matching of time sensitive inventory from a motivated seller to an interested buyer.

The subject matter disclosed herein is based on the insight that the price of an item that may be commanded from certain classes of assets will go to zero at a point in time. Assets that fit these criteria would include seats for travel or space within cargo carriers upon their point of departure in addition to items mentioned earlier. The subject matter disclosed herein uses one or more of email, text, application-based mechanism, and voice technologies to notify potential customers that they may purchase the precise inventory they are looking for at that time at a potentially greatly reduced price, if they want an item immediately. The systems and method disclosed herein may also push data from the potential customers that almost won to the supplier to display to the supplier the potential market for a slightly modified, alternative, or additional offer. In this way, the system is dual push, pushing a product offer of a match of an expressed interest to a potential customer and pushing information on non-winning customers back to the supplier for possible additional sales.

The subject matter disclosed herein may provide a complete, private, personalized, intelligent, continuous, real time communications ecosystem between each individual potential customer and the supplier which offers the ability for the supplier to personalize and improve the potential customer's entire travel experience rather than focusing just on his purchase, focusing not only on those elements which the supplier thinks the potential customer wants but more importantly those elements the potential customer indicates that he wants, which may change at different points or locations during his journey.

In some embodiments, a method is provided for an intelligent, continuous, real time dual push sale of time sensitive inventory. Continuous as used herein refers to the dual push and/or the search for items for the push being repeated frequently in a continuous, such as for example, a near-continuous manner. Real time as used herein refers to the dual push being performed substantially immediately and/or when available for being pushed. And, intelligent as used herein refers to the dual push being based on pattern recognition and/or intelligent processing techniques that weight various factors in connection with the dual push. The method may include receiving a customer specification from a potential customer that has expressed an interest in purchasing an item, and receiving a supplier specification from a supplier that has expressed an interest in offering a matching item whose sales value has a limited lifetime. The method may also include determining a real-time distribution channel that matches the customer specification to the supplier specification and has the potential for dynamic pricing of the offered upsell and cross-sale items. The method may further include conducting a sale where the offered item of the determined real-time distribution channel is made available to matching potential customers, selecting a winning customer of the sale, collecting non-winner data from the potential customers that were not selected and delivers the collected non-winner data to the supplier.

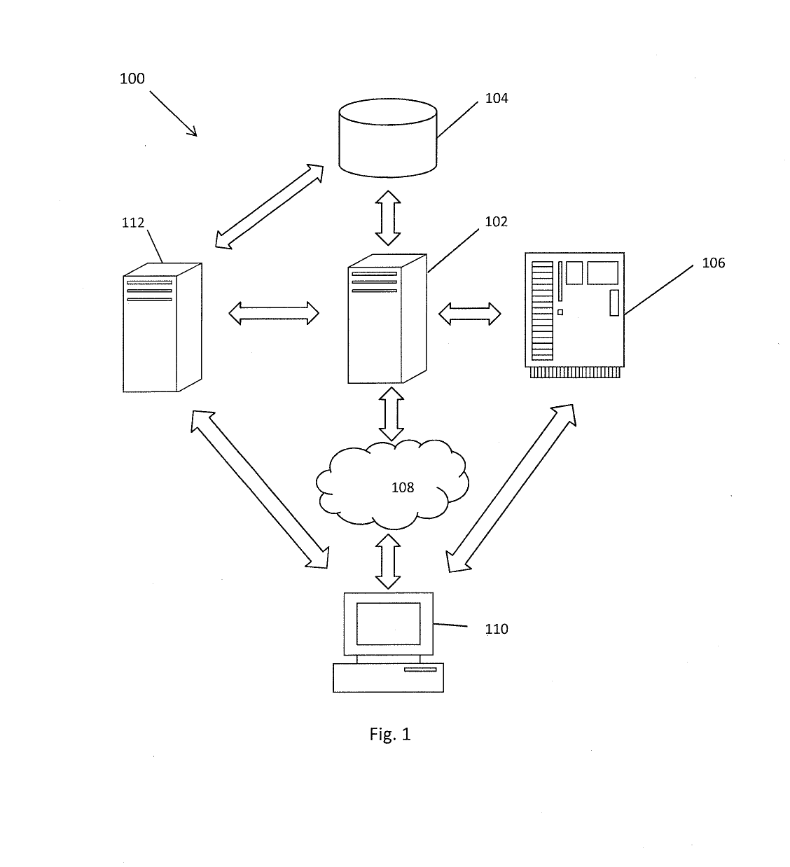

FIG. 1 shows an example system overview 100. A sales portal 102 that comprises one or more sales portal processors is communicably coupled to a vendor inventory database server 104, an electronic mail and simple message service server 106, the World Wide Web 108 and an order fulfillment server 122. The potential customer 110 is communicably coupled to the web 108, the order fulfillment server 112 and the electronic mail and simple message service server 106. Lastly, the order fulfillment server 112 is communicably coupled to the sales portal 102, the vendor inventory database server 104, and the potential customer 110. Although the previous example describes using message texts, such as short message service texts, other forms of communications may be used as well including cellular phone apps, e-mail, voice, and/or any other delivery mechanism.

The sales portal will include four components, an enterprise database, a set of business logic engines, a reporting engine and a suggestion engine. The present system maintains a customer support function and self-serve website interface for subscribers, manages auctions and sales of available inventory, and selects which subscriber obtains specific offered items at what price, manages subscriber interactions and originates the orders to be placed upon completion of sales. Although the terms subscriber and customer are used herein, these may also comprise a user as well.

The enterprise database maintains subscriber account information, including contact information, travel preferences, frequent travel program information and payment details, trips and electronic ticket information, available seat or product inventory to be used within sales, and limitations on that inventory, such as a floor price, electronic commerce information, such as orders that have or will be placed with fulfillment partners, invoices for corporate clients and receipts from invoices, records of customer support calls and transient working data, such as that which would be necessary to support an active sale while still in process. The sale will finalize in a collection of orders, and subsequently, a collection of trips/electronic tickets/receipts/purchase confirmations.

The business logic engines decompose all of the application modules into building blocks that may be extended, but also may handle the same type of function in different ways for different markets. The logic engines are composed of profile management engines and transaction engines.

The profile management engine manages the subscriber's contact information, trip schedule and purchasing history and travel/product preference information, creates views and allows updates and notices for bids/activity in active sales/auctions, and maintains a queue of active electronic tickets and a history of previous trips/purchases.

The transaction engine may handle two or more types of sales, whether of fixed price or auctioned inventory, including the first n-purchasers above a particular price threshold and the second being top n-bidders out of a set of m-bidders who submitted before a deadline. There will be other attractive sales types that may emerge in the future, and the subject matter disclosed herein will support other sales types and a variety of pricing mechanisms.

The inventory management engines are envisioned to interactively or in bulk-fashion upload inventory (seats, rooms, or products), availability (schedules, open dates), deadlines by which the inventory must be placed before it reverts, and limits (price floors, restrictions, segmentation parameters). This is the base data that is matched against subscriber preferences when creating a participant list for a sale. This is then updated continuously based on sales results.

The reporting engine will include records of all transactions, both to the subscribers and to its partners, as appropriate. An aggregate set of continuous, real time behavioral data will allow the suggestion engine to make more and more intelligent offers regarding the types of trips or products that someone may consider, regardless of whether such trips or products are or are not mentioned directly in the customer or supplier specifications. The company believes that an advanced suggestion engine will grow out of the analytic function creating even more value in the future. This engine also, incidentally, handles customer service related reporting and issue tracking.

The suggestion engine of the subject matter disclosed herein is intelligent acting like a virtual assistant or companion for the customer. It learns from the choices, decisions, and actions of the potential customer. This may range from advising the potential customer on other destinations similar to those he has chosen that he may wish to see offers on, constantly monitoring his travel experience and offering things that may make it better or more efficient such as offering an extra legroom seat or business class upgrade where the potential customer is stuck in a middle seat/offering priority security access when the potential customer is running late, to offering advice, such as suggesting an increase in bid to $X if he wants a better chance of winning or try travelling on a Tuesday instead when historically there is more availability or better pricing. It also learns from supplier behavior, geo-location, temporal windows and decisions, so for example if a supplier provides ten seats at $100 and they sell in 5 minutes, suggesting that the supplier either increase the price or provide staggered pricing. Similarly if products don't sell, the system may advise to either lower the price, add fields of people to show the offer to, or to sell at a different time of day (for example there may be very low take-up in the evening but high take-up during the morning).

Additionally the present embodiment may include a web interface for interaction with the subscriber and a messaging gateway for sending instantaneous SMS, email, application, or voice notifications, and allowing for bidding/purchasing and carrying out an entire transaction and managing the entire experience including specifying and updating preferences from a mobile phone.

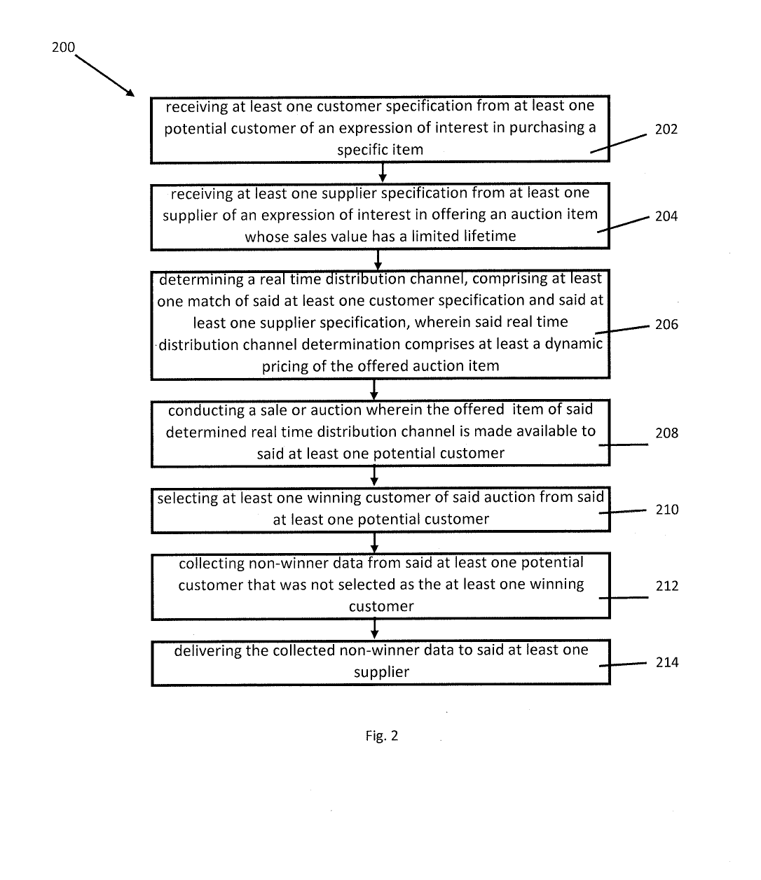

FIG. 2 shows an example method diagram 200. A method of providing a dual push sale of time sensitive inventory that has receiving 202 at least one customer specification from at least one potential customer that has expressed interest in purchasing a specific item and receiving 204 at least one supplier specification from at least one supplier that has expressed an interest in offering a matching item whose sales value has a limited lifetime. The method also includes determining 206 a real time distribution channel, that is comprised of at least one match of the at least one customer specification and the at least one supplier specification, where the real time distribution channel determination has at least a dynamic pricing of the offered upsell and cross-sell items. The method further has conducting 208 a sale where the offered item of the determined real time distribution channel is made available to the at least one potential customer, selecting 210 at least one winning customer of the item from the at least one potential customer, collecting 212 non-winner data from the at least one potential customer that was not selected as the at least one winning customer and delivering 214 the collected non-winner data to the at least one supplier.

The subject matter disclosed herein is push based meaning that a potential customer inputs his individualized customer specification of what he is interested in, and other parameters and preferences—what he is interested in is sent to him in real time as soon as and as often as it becomes available from the supplier whenever it becomes available even if long after the specification is submitted.

The subject matter disclosed herein pushes inventory to people who want to see it when they want to see it as communicated by them. This may vary from a potential customer who wants a ticket to London to a potential customer who wants a ticket to London tomorrow, to a potential customer who wants a ticket to London tomorrow leaving before noon to a potential customer who wants all of this on United Airlines and potentially only if its available at a fixed price less than $500. Other examples include a potential customer who wants to go to an undefined location at a specified time but is open to travel options based on price and the like. The push functionality is customized by each potential customer, each and every time a customer uses the system to create truly individualized offerings

The potential customer inputs preferences in his customer specification in the customer portal. Nothing that he inputs is an offer to purchase or a bid, whether conditional or otherwise, it is an expression of interest. Similarly, rules and conditions are determined by the supplier prior to inventory entering the system through the supplier portal so that when it does enter the system and reaches each qualifying recipient, that inventory takes the form of either an unconditional sales offer, in the case of a fixed price item, or a no floor bid, or a conditional sales offer in the case of a reserve bid item. The potential customer decides whether and how to respond to each and every item offered. There is limited ability for the supplier to refuse to sell the item if the price parameters have been met.

The subject matter disclosed herein gathers detailed data on non-winning purchasers and bidders and subject to their consent pushes this data back to the supplier for review and action. The subject matter disclosed herein collates all non-winning bidding and buying activity, sorts it by price and other fields such as number of tickets requested and location of customer and sends that data to the supplier for them to determine if they want to make an alternative inventory offer to those non-winning potential customers. This data creates an entire new transaction source for the supplier. For example if the supplier is selling five seats from Houston to London at the highest bid and there are 100 bids with the highest bid being $500 and the lowest bid being $50, the supplier knows based on this data that there are 95 additional people willing to travel on that route on that day for a price ranging from $50 to $499. While some of the potential customers who placed the lowest bids may not be of interest, many of those bidders who bid close to the winning bid are of significant interest as the supplier may either offer additional inventory to them on the same route and day either at the winning bid or a premium, offer alternative inventory to them for the winning bid, at a premium, or at a different price, and/or store their details to use for future distressed inventory. The real time, personalized nature of the system disclosed herein may allow a multiplicity of different offers to be made discreetly in a highly targeted manner.

The subject matter disclosed herein allows for multiple drops of inventory into the system with alternative pricing mechanisms so that the supplier may be conservative with the initial inventory it releases and then release additional inventory to reflect actual demand and allows for flexibility on pricing, distribution and other criteria. The subject matter disclosed herein relies on notifications from the system continuously and immediately being pushed out to the potential customer as soon as product is available matching their exact preferences and the information of the non-sales is pushed back to the supplier. If multiple items match the preference either at the time the preference is submitted or later, each match will be prioritized by the system's intelligence and the time received and by the system disclosed herein, and then pushed to the customer in accordance with the prioritization.

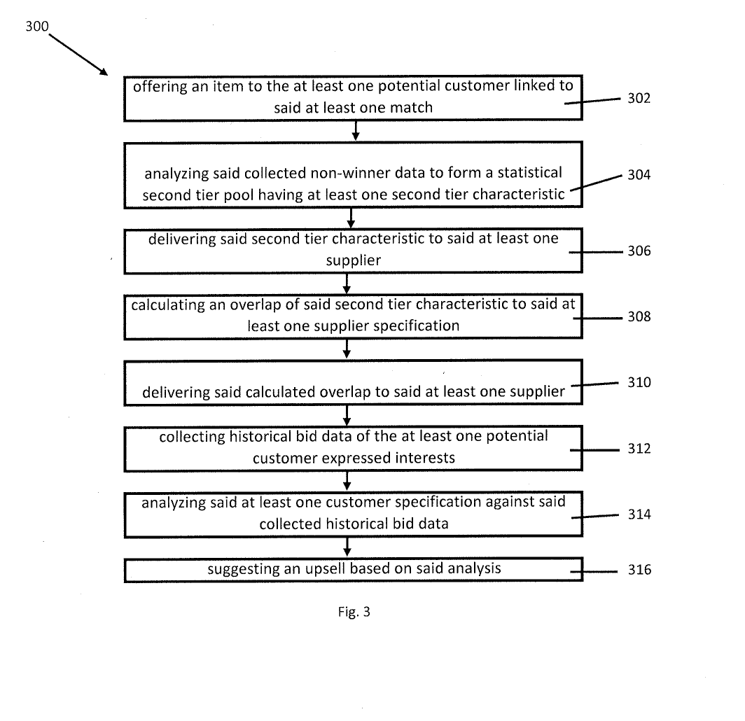

FIG. 3 shows a second example method diagram 300. The method may also have offering 302 the available item to the at least one potential customer linked to the at least one match, analyzing 304 the collected non-winner data to form a statistical second tier pool having at least one second tier characteristic and delivering 306 the second tier characteristic to the at least one supplier. The method may additionally have calculating 308 an overlap of the second tier characteristic to the at least one supplier specification, delivering 310 the calculated overlap to the at least one supplier, collecting 312 historical bid/purchasing data of the at least one potential customer expressed interests, analyzing 314 the at least one customer specification against the collected historical bid/purchasing data, and suggesting 316 an upsell or cross-sell based on the analysis.

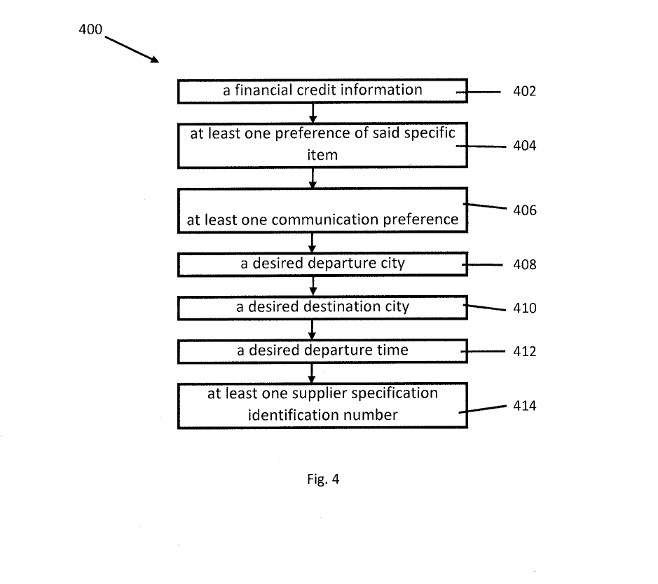

FIG. 4 shows the customer specification 400. The customer specification may also have at least one of a financial credit information 402, at least one preference of the specific item 404, at least one communication preference 406, a desired departure city 408, a desired destination city 410, a desired departure time 412 and at least one supplier specification identification number 414.

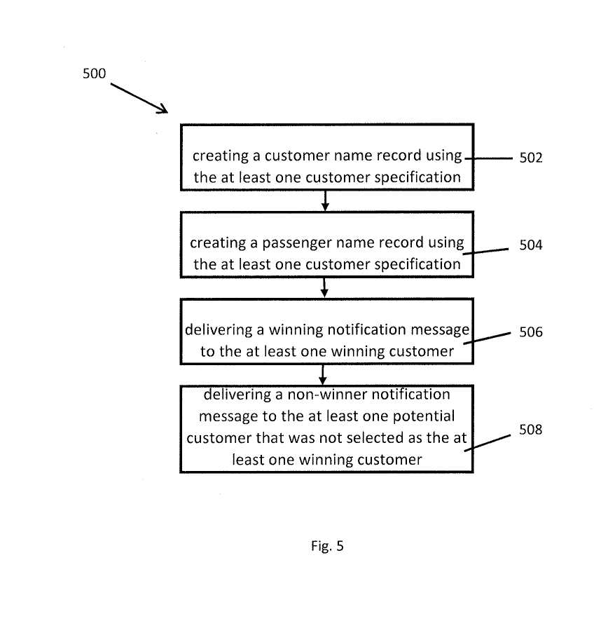

FIG. 5 shows a third example method diagram 500. The method may additionally comprise creating 502 a customer name record using the at least one customer specification and creating 504 a passenger name record using the at least one customer specification, delivering 506 a winning notification message to the at least one winning customer and delivering 508 a non-winner notification message to the at least one potential customer that was not selected as the at least one winning customer. Dynamic pricing has at least a regression analysis to determine highest prices for the offered item.

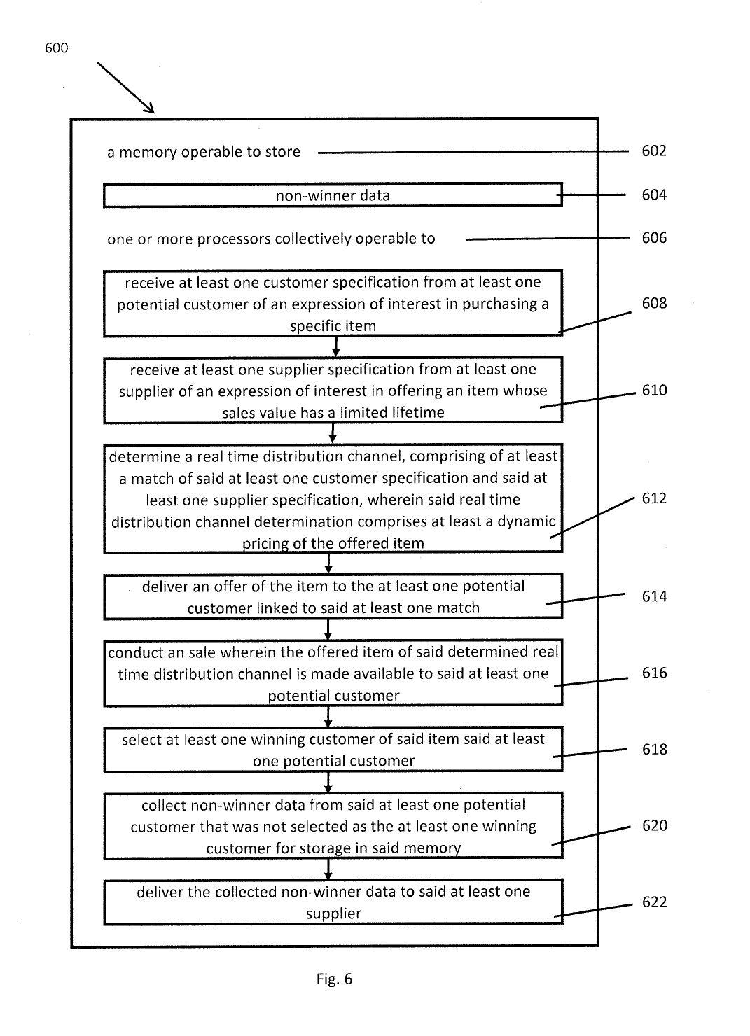

FIG. 6 shows an example system diagram 600. A system for providing a dual push sale of time sensitive inventory, the system has a memory 602 operable to store non-winner data 604 and one or more sales portal processors 606 coupled to the memory and collectively operable to receive 608 at least one customer specification from at least one potential customer of an expression of interest in purchasing a specific item and receive 610 at least one supplier specification from at least one supplier of an expression of interest in offering an item whose sales value has a limited lifetime. The one or more sales portal processors also determine 612 a real time distribution channel, having at least a match of the at least one customer specification and the at least one supplier specification where the real time distribution channel determination has at least a dynamic pricing of the offered upsell or cross-sell item. The one or more sales portal processors additionally deliver 614 an offer of the offered item to the at least one potential customer linked to the at least one match, conduct 616 a sale where the offered item of the determined real time distribution channel is made available to the at least one potential customer, select 618 at least one winning customer of the item from the at least one potential customer, collect 620 non-winner data from the at least one potential customer that was not selected as the at least one winning customer for storage in the memory and deliver 622 the collected non-winner data to the at least one supplier.

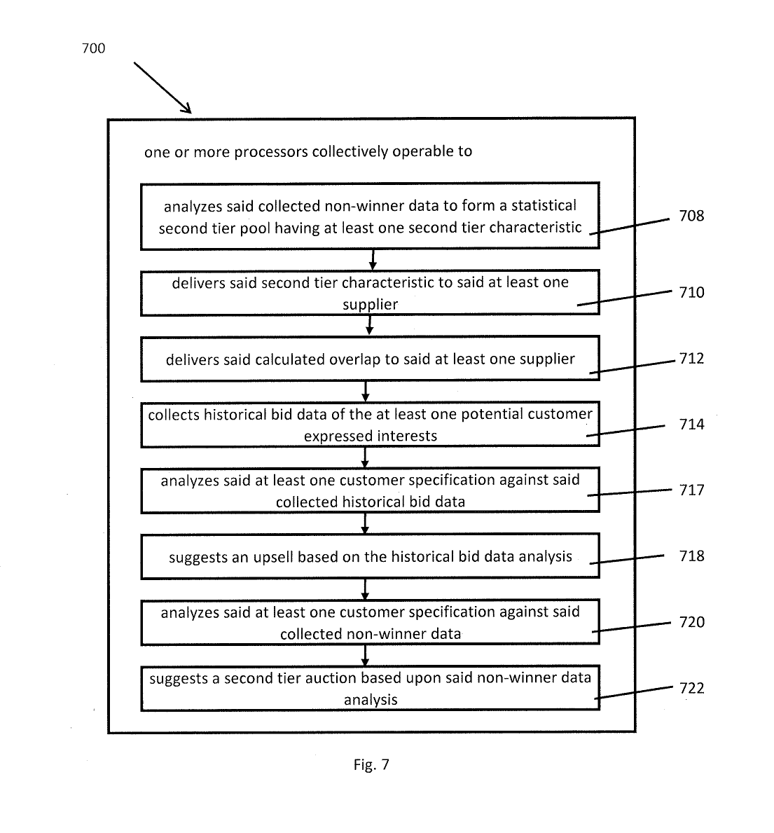

FIG. 7 shows a second example system diagram 700. The system may also have one or more sales portal processors which analyze 702 the collected non-winner data to form a statistical second tier pool having at least one second tier characteristic, deliver 704 the second tier characteristic to the at least one supplier, calculate 706 an overlap of the second tier characteristic to the at least one supplier specification, deliver 708 the calculated overlap to the at least one supplier. The one or more sales portal processors may also collect 710 historical bid/purchasing data of the at least one potential customer expressed interests, analyze 712 the at least one customer specification against the collected historical bid/purchasing data, suggest 714 an upsell or cross-sell based on the historical bid/purchasing data analysis, analyze 716 the at least one customer specification against the collected non-winner data and suggest 718 a second tier sale based upon the non-winner data analysis.

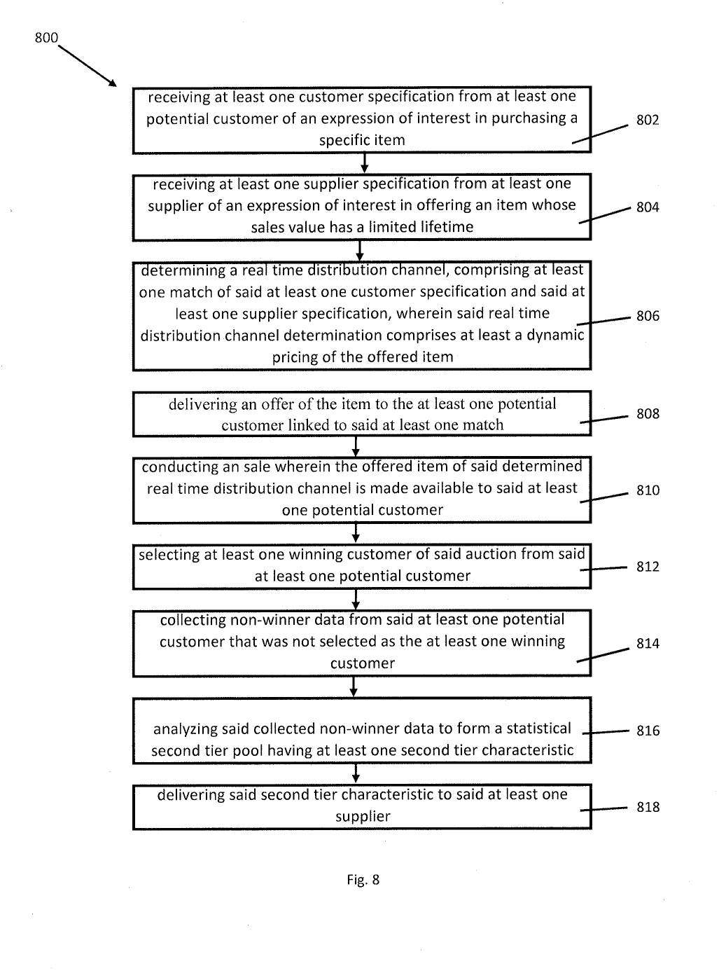

FIG. 8 shows an example computer readable medium diagram 800. A computer readable medium having computer instructions for controlling one or more sales portal processors that provides a dual push sale of time sensitive inventory, executing the steps of receiving 802 at least one customer specification from at least one potential customer of an expression of interest in purchasing a specific item, receiving 804 at least one supplier specification from at least one supplier of an expression of interest in offering an item whose sales value has a limited lifetime and determining 806 a real time distribution channel, having at least a match of the at least one customer specification and the at least one supplier specification, where the real time distribution channel determination has at least a dynamic pricing of the offered upsells and cross-sells. The computer instructions also include delivering 808 an offer of the item to the at least one potential customer linked to the at least one match, conducting 810 a sale where the offered item of the determined real time distribution channel is made available to the at least one potential customer and selecting 812 at least one winning customer of the sale from the at least one potential customer. The computer instructions also include collecting 814 non-winner data from the at least one potential customer that was not selected as the at least one winning customer, analyzing 816 the collected non-winner data to form a statistical second tier pool having at least one second tier characteristic and delivering 818 the second tier characteristic to the at least one supplier.

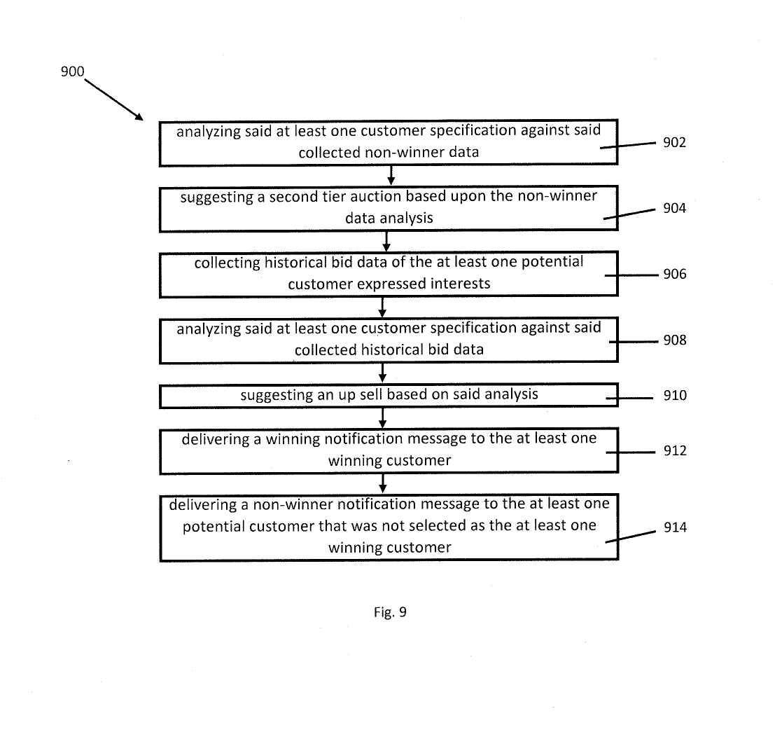

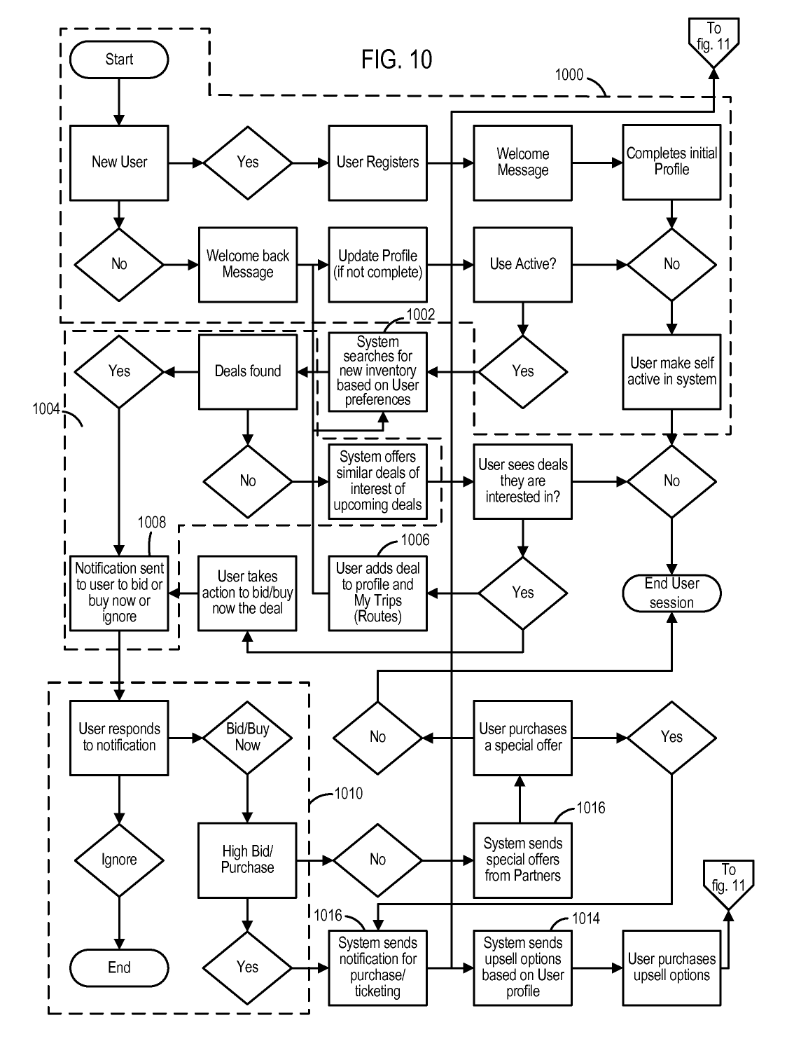

FIG. 9 shows a second example computer readable medium diagram 900. The computer readable medium may also have instructions for analyzing 902 the at least one customer specification against the collected non-winner data, suggesting 904 a second tier sale based upon the non-winner data analysis, collecting 906 historical bid/purchasing data of the at least one potential customer expressed interests and analyzing 908 the at least one customer specification against the collected historical bid/purchasing data. The computer readable medium may also comprise instructions for suggesting 910 an up-sell or cross-sell based on the analysis, delivering 912 a winning notification message to the at least one winning customer and delivering 914 a non-winner notification message to the at least one potential customer that was not selected as the at least one winning customer. The non-winner may receive repeated additional offerings as well. FIG. 10 depicts an example of a flowchart, in accordance with some example implementations. In the example depicted at FIG. 10, the system initially determines if the user is new to the system or an existing customer, and either prompts the user to register or welcomes back the customer. The system then receives specifications of interest from the customer, such as departure cities, destinations, desired times, and preferred communication channels, and continuously searches for inventory in accordance with customer preferences 1002 and presents the customer with deals that meet the customer preferences or, if requested by the customer, that are similar 1004. Once a customer expresses interest in a particular deal, the deal is added to the customer profile 1006. This information is used to set additional customer preferences and present the customer with additional deals 1004, offering the item by sending notifications of particular deals to the customer 1008. A customer can ignore a deal, or take action in accordance with its terms, which may be to purchase the item or participate in an auction for the inventory of the item 1010. If the customer purchases or wins an auction for an item, the system completes the purchase and delivers a notification of the purchase to the customer 1012 and adds a record of the deal to the user profile 1014, using the information to offer upsells and cross-sells to the customer. If the customer participates in an auction for a deal but does not submit a successful bid, the system will present additional offers and second-tier auctions 1016 based upon the analysis of the customer interest in the auctioned inventory.

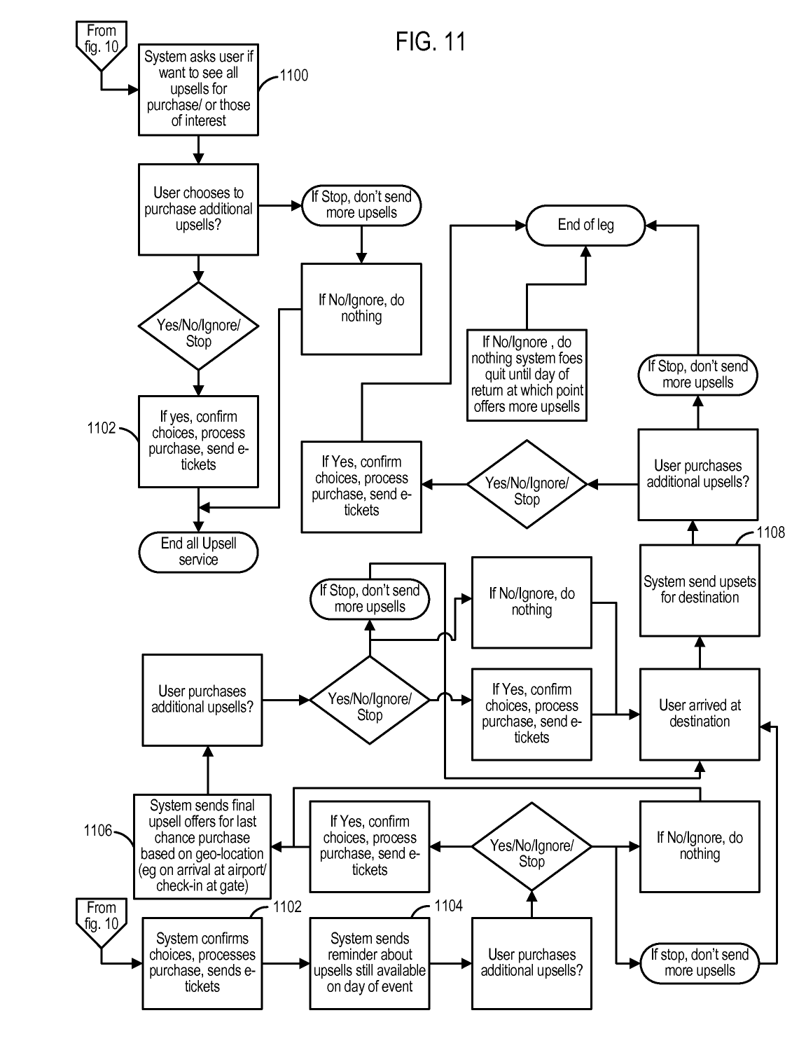

FIG. 11 depicts an additional flowchart of the user experience. In this flowchart, the process for presenting additional upsells and cross-sells is shown. On the flowchart, the items are generally referred to as upsells, however, while the item can present a true upsell, such as an upgraded airline class, it can also be a cross-sell, such as a restaurant or hotel deal at the destination. In FIG. 11, the system requests the customer opt-in for further recommended deals en route and at the destination. Upsells at the time of purchase of the primary item are processed and confirmations of the purchases are sent to the customer 1102. The system uses the purchase history and activity data stored in the customer profile to offer additional upsells on the day of particular events, such as airline departure 1104, and will also employ geo-location to offer additional upsells 1106, such as when the customer is at the airport of departure. Additional upsells are offered based upon the geo-location of the customer when the destination is reached 1108.

Reviewing FIGS. 10 & 11, it can be appreciated that in addition to the method of sale already detailed by the prior figures, the cross-sell and upsell process interacts with the customer in different ways at numerous times during the purchase process and product experience. Instead of offering supplier recommended upsells at the time of sale, the subject matter disclosed herein may offer user requested and intelligently recommended upsells and/or cross-sells throughout the experience until the consumer returns home and uses geo-location and analysis of intended position at intended time versus current position at current time to offer the customer opportunities for a more robust experience. For example, the system not only provides upsells while a customer is at an airport, but can use the information on whether the customer has arrived early or late, and whether a flight is delayed, to determine if a customer would be more responsive to expedited check-in or lounge access and tailor offerings accordingly. The system also recognizes the perishable nature of such offerings, and, in connection with parameters set by suppliers, adjusts prices dynamically.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively, or additionally, store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving at least one customer specification from at least one potential customer of an expression of interest in purchasing a specific item;
receiving at least one supplier specification from at least one supplier of an expression of interest in offering an item whose sales value has a limited lifetime;
determining a real time distribution channel, comprising at least one match of said at least one customer specification and said at least one supplier specification, wherein said real time distribution channel determination comprises at least a dynamic pricing of the set of the desired item, upsells and cross-sells;
conducting a sale wherein the offered item of said determined real time distribution channel is made available to said at least one potential customer;
selecting at least one winning customer of said sales from said at least one potential customer;
collecting non-winner data from said at least one potential customer that was not selected as the at least one winning customer; and
delivering the collected non-winner data to said at least one supplier.

2. The method of claim 1 further comprising:
offering the item to the at least one potential customer linked to said at least one match.

3. The method of claim 1 further comprising:
analyzing said collected non-winner data to form a statistical second tier pool having at least one second tier characteristic; and
delivering said second tier characteristic to said at least one supplier.

4. The method of claim 3 further comprising:
calculating an overlap of said second tier characteristic to said at least one supplier specification; and
delivering said calculated overlap to said at least one supplier.

5. The method of claim 1 further comprising:
collecting historical bid/purchasing data of the at least one potential customer expressed interests;
analyzing said at least one customer specification against said collected historical bid/purchasing data; and
suggesting an upsell/cross-sell based on said analysis.

6. The method of claim 1 wherein said customer specification may comprise at least one of:
a financial credit information;
at least one preference of said specific item; and
at least one communication preference.

7. The method of claim 1, wherein the match is determined in a substantially continuous manner.

8. A system comprising:
at least one processor; and
at least one memory including code which when executed provides operations comprising:
receiving at least one customer specification from at least one potential customer of an expression of interest in purchasing a specific item;
receiving at least one supplier specification from at least one supplier of an expression of interest in offering an item whose sales value has a limited lifetime;
determining a real time distribution channel, comprising at least one match of said at least one customer specification and said at least one supplier specification, wherein said real time distribution channel determination comprises at least a dynamic pricing of the set of the desired item, upsells and cross-sells;
conducting a sale wherein the offered item of said determined real time distribution channel is made available to said at least one potential customer;
selecting at least one winning customer of said sales from said at least one potential customer;
collecting non-winner data from said at least one potential customer that was not selected as the at least one winning customer; and
delivering the collected non-winner data to said at least one supplier.

9. The system of claim 8 further comprising:
offering the item to the at least one potential customer linked to said at least one match.

10. The system of claim 8 further comprising:
analyzing said collected non-winner data to form a statistical second tier pool having at least one second tier characteristic; and
delivering said second tier characteristic to said at least one supplier.

11. The system of claim 10 further comprising:
calculating an overlap of said second tier characteristic to said at least one supplier specification; and
delivering said calculated overlap to said at least one supplier.

12. The system of claim 8 further comprising:
collecting historical bid/purchasing data of the at least one potential customer expressed interests;
analyzing said at least one customer specification against said collected historical bid/purchasing data; and
suggesting an upsell/cross-sell based on said analysis.

13. The system of claim 8 wherein said customer specification may comprise at least one of:
a financial credit information;
at least one preference of said specific item; and
at least one communication preference.

14. The system of claim 8, wherein the match is determined in a substantially continuous manner.

15. A non-transitory computer-readable storage medium including code, which when executed by at least one processor provides operations comprising:
receiving at least one customer specification from at least one potential customer of an expression of interest in purchasing a specific item;
receiving at least one supplier specification from at least one supplier of an expression of interest in offering an item whose sales value has a limited lifetime;
determining a real time distribution channel, comprising at least one match of said at least one customer specification and said at least one supplier specification, wherein said real time distribution channel determination comprises at least a dynamic pricing of the set of the desired item, upsells and cross-sells;
conducting a sale wherein the offered item of said determined real time distribution channel is made available to said at least one potential customer;
selecting at least one winning customer of said sales from said at least one potential customer;
collecting non-winner data from said at least one potential customer that was not selected as the at least one winning customer; and
delivering the collected non-winner data to said at least one supplier.
